(19) United States
(12) Patent Application Publication
(10) Pub. No.: US 2025/0238659 A1
(43) Pub. Date: Jul. 24, 2025

(54) UNCERTAINTY CALIBRATION METHOD OF PREDICTION AND CALIBRATION APPARATUS

(71) Applicants: Hon Hai Precision Industry Co., Ltd., New Taipei City (TW); FOXCONN TECHNOLOGY GROUP CO., LTD, Shenzhen (CN)

(72) Inventors: Chengtai Cao, New Taipei City (TW); Jianping Wang, New Taipei City (TW); Yi-Rong Lin, New Taipei City (TW); Nien-Yi Jan, New Taipei City (TW); Yung-Hui Li, New Taipei City (TW); Kai-Lin Yang, New Taipei City (TW)

(73) Assignees: Hon Hai Precision Industry Co., Ltd., New Taipei City (TW); FOXCONN TECHNOLOGY GROUP CO., LTD, Shenzhen (CN)

(21) Appl. No.: 19/026,309

(22) Filed: Jan. 16, 2025

Related U.S. Application Data
(60) Provisional application No. 63/622,082, filed on Jan. 18, 2024.

(51) Int. Cl. G06N 3/045

(52) U.S. Cl. CPC G06N 3/045

(57) ABSTRACT

An uncertainty calibration method of prediction and a calibration apparatus are provided. One or more additional features are extracted from the data set. The calibration scaling factor is output by inputting the additional features into the decoder. The online prediction is output by inputting the data to be evaluated into the trained prediction model. The calibration scaling factor is used to adjust the variance of the online prediction, where the variance corresponds to the range of variation of the online prediction.

### CROSS-REFERENCE TO RELATED APPLICATION

This application claims the priority benefit of U.S. provisional application Ser. No. 63/622,082, filed on Jan. 18, 2024. The entirety of the above-mentioned patent application is hereby incorporated by reference herein and made a part of this specification.

### BACKGROUND

### Technical Field

The disclosure relates to a calibration technology, and in particular relates to an uncertainty calibration method of prediction and a calibration apparatus.

### Description of Related Art

Autonomous driving systems rely on accurate trajectory prediction to achieve safe and efficient motion planning. The trajectory prediction function of an autonomous driving system may predict the future location of surrounding vehicles. The planning function of the autonomous driving system uses these predicted outputs (i.e., future locations) to derive a collision-free motion path. The interdependence of the above two functions raises urgent concerns that inaccurate predictions may affect planning safety or even lead to serious accidents. Due to data noise and incomplete observations, inherent uncertainties persist. Therefore, resolving the uncertainty between these two functions is crucial for ensuring driving safety.

### SUMMARY

An uncertainty calibration method of prediction and a calibration apparatus, which may improve the prediction accuracy in related fields, are provided in the disclosure.

The uncertainty calibration method of prediction in the embodiment of the disclosure is implemented by a processor. The uncertainty calibration method of prediction includes (but is not limited to) the following operation. One or more additional features are extracted from a data set. A calibration scaling factor is output by inputting the additional features into a decoder. An online prediction is output by inputting data to be evaluated into a trained prediction model. A variance of the online prediction is adjusted by using the calibration scaling factor, in which the variance corresponds to a range of variation of the online prediction.

The calibration apparatus of the embodiment of the disclosure includes (but is not limited to) a memory and a processor. The storage is configured to store program code. The processor is coupled to the storage. The processor is configured to load the program code to execute the following operation. One or more additional features are extracted from a data set. A calibration scaling factor is output by inputting the additional features into a decoder. An online prediction is output by inputting data to be evaluated into a prediction model. A variance of the online prediction is adjusted by using the calibration scaling factor, in which the variance corresponds to a range of variation of the online prediction.

Based on the above, the uncertainty calibration method of prediction and the calibration apparatus according to the embodiment of the disclosure may extract additional features from the data set, generate a calibration scaling factor based on the additional features, and use the calibration scaling factor to scale down or scale up the variance in another prediction result from the prediction model. This may improve the accuracy of trajectory prediction and improve the performance of motion planning.

In order to make the above-mentioned features and advantages of the disclosure comprehensible, embodiments accompanied with drawings are described in detail below.

### BRIEF DESCRIPTION OF THE DRAWINGS

FIG. 1 is an element block diagram of a calibration apparatus according to an embodiment of the disclosure.

FIG. 2 is a flowchart of regularization training according to an embodiment of the disclosure.

FIG. 3 is a schematic diagram of regularization training according to an embodiment of the disclosure.

FIG. 4 is a flowchart of an uncertainty calibration method of prediction according to an embodiment of the disclosure.

FIG. 5A is a schematic diagram of prediction and post-training (Post-training) according to an embodiment of the disclosure.

FIG. 5B is a schematic diagram of post-training according to an embodiment of the disclosure.

FIG. 6 is a flowchart of spatiotemporal feature extraction according to an embodiment of the disclosure.

FIG. 7 is a schematic diagram of calibration according to an embodiment of the disclosure.

FIG. 8A to FIG. 8C are schematic diagrams illustrating performance verification according to an embodiment of the disclosure.

FIG. 9 is a schematic diagram illustrating performance verification of multiple basic elements according to an embodiment of the disclosure.

FIG. 10 is a diagram illustrating the relationship between sample size and expected calibration error (ECE) according to an embodiment of the disclosure.

### DETAILED DESCRIPTION OF DISCLOSED EMBODIMENTS

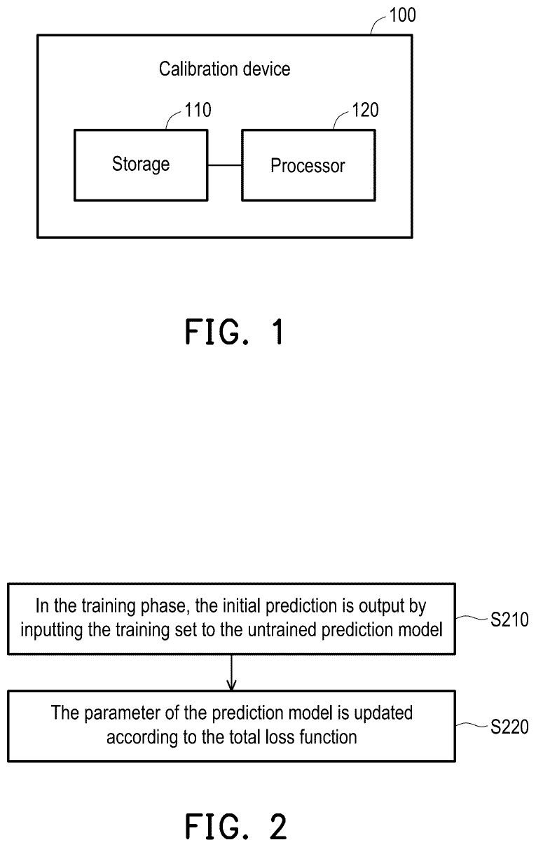

FIG. 1 is an element block diagram of a calibration apparatus 100 according to an embodiment of the disclosure. Referring to FIG. 1, the calibration apparatus 100 includes (but is not limited to) a memory 110 and a processor 120. The calibration apparatus 100 may be a mobile phone, a tablet, a laptop, a desktop computer, a server, a voice assistant apparatus, a smart home appliance, a wearable apparatus, a vehicle-mounted system, or other electronic apparatuses.

The storage 110 may be any type of fixed or movable random access memory (RAM), read only memory (ROM), flash memory, conventional hard disk drive (HDD), solid-state drive (SSD) or similar elements. In one embodiment, the storage 110 is configured to store program codes, software modules, configurations, data (e.g., model parameters, data sets, samples, features, predictions, factors, or variances) or files, which are described in detail in subsequent embodiments.

The processor 120 is coupled to the storage 110. The processor 120 may be a central processing unit (CPU), a graphics processing unit (GPU), or other programmable general-purpose or special-purpose microprocessors, a digital signal processor (DSP), a programmable controller, a field programmable gate array (FPGA), an application-specific integrated circuit (ASIC), a neural processing unit (NPU), a tensor processing unit (TPU), an artificial intelligence (AI) accelerator, a neural engine, or other similar elements, or a combination of the elements thereof. In one embodiment, the processor 120 is configured to execute all or some of the operations of the calibration apparatus 100, and may load and execute various program codes, software modules, files, and data stored in the storage 110.

Hereinafter, the method according to the embodiment of the disclosure is described in conjunction with various apparatuses, elements, and modules in the calibration apparatus 100. Each process of the method may be adjusted according to the implementation, and is not limited to thereto.

FIG. 2 is a flowchart of regularization training according to an embodiment of the disclosure. Referring to FIG. 2, in the training phase, the processor 120 outputs an initial prediction by inputting a training set to an untrained prediction model (step S210). Specifically, the training set includes one or more training samples. Depending on different application scenarios, training samples may be images, videos, sounds, sensing intensity, distance, angle, amplitude, location, trajectory, quantity or other forms/types/modalities.

In one application scenario, the prediction model is configured to predict the trajectory of the target object. The target object may be any type of mobile vehicle (e.g., a car, a motorcycle, or a truck), a person, or other animal. The target object may be adjacent to the main object. The definition of adjacency is related to the distance between the target object and the main object, and may be adjusted according to actual requirements, for example, target objects within the sensing range of the sensor. The main object may be any type of mobile vehicle (e.g., a car, motorcycle, or truck), a person, or other animal. In one application scenario, an autonomous vehicle or vehicle-mounted system uses a prediction model to predict the trajectory of adjacent target objects at future time points. A trajectory includes or is related to the location of one or more time points, their sequence, and the direction of transition. In some application scenarios, the trajectory may be recorded as one or more timestamps and their corresponding locations (e.g., longitude, latitude, geography, or coordinates of other coordinate systems). A future time point is a time point subsequent to a reference time point (e.g., the current time point). For example, the reference time point is twelve hours, twelve minutes, and eleven seconds (12:12:11), and the future time point is twelve hours, twelve minutes, and thirteen seconds (12:12:13).

In one embodiment, the training samples may include historical trajectories and future trajectories (as the ground truth corresponding to the historical trajectories). A historical trajectory includes or is related to the location of one or more past time points, their sequence, and the direction of transition. A past time point is a time point prior to a reference time point (e.g., the current time point). For example, the reference time point is twelve hours, twelve minutes, and eleven seconds (12:12:11), and the past time point is twelve hours, twelve minutes, and ten seconds (12:12:10). A future trajectory includes or is related to the location of one or more future time points, their sequence, and the direction of transition. The definitions and examples of future time points are as explained above and are not repeated herein.

In one embodiment, the training samples may include sensing data and future trajectories (as the ground truth corresponding to the sensing data). The main object may be loaded with or carry sensors, thereby obtaining sensing data related to images, sounds, distances, and directions. Sensing data may be configured to generate the positional relationship between the main object and the target object, for example, relative distance or direction. The sensing data may be configured to generate motion information of the main object and/or the target object, for example, velocity, acceleration, or pose.

In one embodiment, the training samples may further include environmental information. The main object may be loaded with or carry sensors, thereby obtaining sensing data related to images, sounds, distances, temperatures, and humidity (which may be used as training samples). The environmental information is, for example, the above-mentioned sensing data.

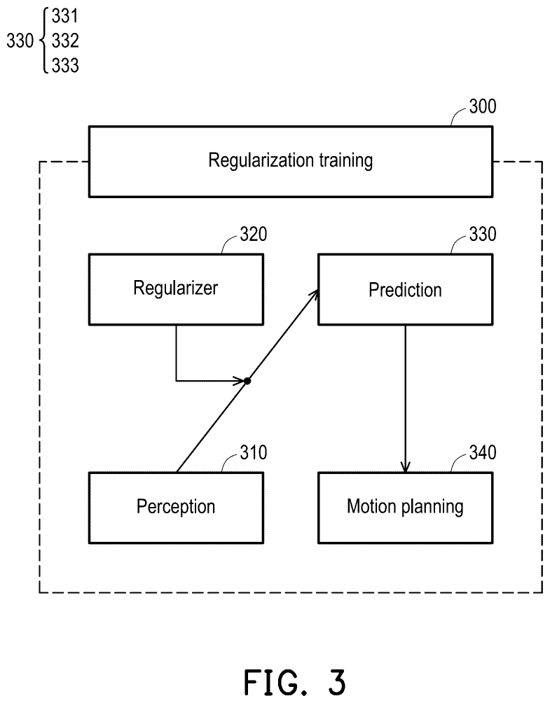

FIG. 3 is a schematic diagram of regularization training according to an embodiment of the disclosure. Referring to FIG. 3, the processor 120 may train a prediction model through a machine learning algorithm. The machine learning algorithm may analyze labeled training samples (e.g., historical trajectories and/or sensing data with corresponding ground truth) to correlations between historical trajectories and/or sensing data (i.e., the input to the model, perception data 310 as shown in the figure) and future trajectories (i.e., the output of the model, prediction 330 as shown in the figure). The prediction model may be trained and may make inferences based on the data to be evaluated (e.g., perception data 310 to be evaluated) to output the prediction 330 corresponding to the perception data 310.

The type of machine learning algorithm may change depending on the application scenario. Taking trajectory prediction as an example, the machine learning algorithm may be an encoder-decoder long short-term memory (ED-LSTM), a hierarchical vector transformer (HiVT), a transformer in transformer (TNT), a learning lane graph representations for motion forecasting (LaneGCN), or autonomous robots (AutoBots), but not limited thereto. In other application scenarios, the machine learning algorithm may be multi-layer perception (MLP), a convolutional neural network (CNN), a long short-term memory (LSTM) network, or a temporal convolutional network (TCN) (e.g., Conv-TasNet), but not limited thereto.

In one embodiment, the prediction 330 includes an initial prediction 331. The prediction 330 derived by the prediction model from one or more training samples (e.g., historical trajectories and/or sensing data) in the input training set is the initial prediction 331 (e.g., future trajectory).

In one embodiment, during the training phase of the prediction model, the parameters of the prediction model are recursively updated by minimizing the loss function (related to the error/loss between the output (i.e., initial prediction 331) of the prediction model and the ground truth (e.g., future trajectory) in the training sample). The parameters of the model are, for example, the weight, number of layers, location or number of neurons, activation function, or offset, but not limited thereto. The method of updating parameters is, for example, through a gradient descent, an adaptive moment estimation (Adam) optimizer, a momentum method, an adaptive gradient (Adagrad), or a conjugate gradient method, but not limited thereto. That is, one of the multiple objectives of the training phase is to align the initial prediction output by the prediction model close to or the same as the corresponding ground truth.

Referring to FIG. 2, the processor 120 updates the parameters of the prediction model according to the total loss function (step S220). Specifically, one of the multiple objectives of the training phase is to minimize the total loss function. In one embodiment, the total loss function is the sum of negative log-likelihood (NLL) and the calibration loss function. For example, the mathematical expression of the total loss function L_{CCTR} is:

$${L}_{CCTR} = {L}_{NNL} + {L}_{CAL} , \qquad ( 1 )$$

where L_{NNL} is the negative log-likelihood, and L_{CAL} is the calibration loss function.

The mathematical expression of negative log-likelihood L_{NNL} is:

$${L}_{NNL} = - log P ( {y}_{i} \vert \hat{{μ}_{i}} , {\hat{σ}}_{i} ) . \qquad ( 2 )$$

P(yᵢ|\hat{μ}ᵢ, \hat{σ}ᵢ) is the distribution P under the initial prediction \hat{μ}ᵢ (e.g., i^{th} initial prediction) made by the prediction model accompanied by the variance \hat{σ}ᵢ (e.g., the uncertainty corresponding to the i^{th} training sample) under the condition of the ground truth yᵢ (e.g, the i^{th} future trajectory). For example, the training set includes N training samples {xᵢ,yᵢ,hᵢ}ᵢ₌₁^{N}. By inputting the training samples (xᵢ,yᵢ,hᵢ) to the prediction model, the distribution P under the initial prediction \hat{μ}ᵢ is accompanied by the variance \hat{σ}ᵢ (or the uncertainty corresponding to the initial prediction \hat{μ}ᵢ), where xᵢ is the i^{th} historical trajectory, and hᵢ is the i^{th} environmental information. The distribution P is a predefined distribution, such as a Gaussian distribution, but not limited thereto.

However, training samples are not limited to historical trajectories and environmental information, and may be changed according to application requirements. The variance \hat{σ}ᵢ corresponds to the range of variation of the initial prediction \hat{μ}ᵢ. Taking trajectory prediction as an example, the initial prediction \hat{μ}ᵢ is the future trajectory corresponding to the i^{th} historical trajectory and environmental information. Assuming that the future trajectory is a location at a certain future time, the variance \hat{σ}ᵢ is the range/area of variation of this location. That is, this location may occur within a specific range/area defined by the variance \hat{σ}ᵢ. For example, the prediction model predicts that the location at this future time point is within this range/area of variation. The larger the variance \hat{σ}ᵢ, the larger the range/area of variation, and the maximum variation in location is further away from the original predicted location; the smaller the variance \hat{σ}ᵢ, the smaller the range/area of variation, and the maximum variation in location is closer to the original predicted location.

The mathematical expression of the calibration loss function L_{CAL} is:

$${L}_{CAL} = {‖ ( {y}_{i} - \hat{{μ}_{i}} ) \cdot ( {y}_{i} - \hat{{μ}_{i}} ) - {\hat{σ}}_{i} ‖}_{2} . \qquad ( 3 )$$

The calibration loss function L_{CAL} regularizes the difference between the first value and the second value, the first value (i.e., (yᵢ−\hat{μ}ᵢ)·(yᵢ−\hat{μ}ᵢ)) is the square of the difference (e.g., obtained by subtracting the ground truth yᵢ and the initial prediction \hat{μ}ᵢ) between the initial prediction \hat{μ}ᵢ and the corresponding ground truth yᵢ, and the second value is the variance \hat{σ}ᵢ of the initial prediction \hat{μ}ᵢ. The variance \hat{σ}ᵢ should match the actual difference between the initial prediction \hat{μ}ᵢ and the ground truth yᵢ. For example, (yᵢ−\hat{μ}i)·(yᵢ−\hat{μ}ᵢ)=\hat{σ}ᵢ.

As shown in FIG. 3, in the regularization training 300, the regularizer 320 additionally assigns a calibration loss function L_{CAL} to the difference between the initial prediction 331 and the ground truth. In one embodiment, the prediction 330 includes an online prediction 332. The processor 120 may output the online prediction 332 by inputting the data to be evaluated into the trained prediction model. The prediction 330 derived by the trained prediction model from the input data to be evaluated (e.g., historical trajectory and/or sensing data) is the online prediction 332 (e.g., future trajectory, locations at future time points or other derived results). In one embodiment, a trained prediction model means that its (total) loss function has converged, the prediction accuracy has reached the corresponding threshold, or the training has reached the standard for early stopping, but the trained standard may still be adjusted according to other tasks or requirements.

In one embodiment, online prediction 332 may be configured to determine motion planning data (i.e., motion planning 340 shown in FIG. 3) of the main object. The motion planning data includes motion parameters of the main object at one or more future time points. The motion parameters are, for example, velocity, acceleration, direction, angular velocity, pose, or a combination thereof. The algorithm related to motion planning is, for example, known as rapidly-exploring random tree (RRT) or neural message passing (NMP), but not limited thereto.

These algorithms may calculate a series of actions or control commands to guide the robot or mobile vehicle (i.e., the main object) from the starting state to the target state safely and efficiently, while satisfying one or more limiting conditions (e.g., avoiding obstacles, obeying traffic rules, etc.). The processor 120 may generate control commands for a main object (e.g., a vehicle or a vehicle-mounted system) according to the motion parameters. The control commands are used, for example, to accelerate, brake, turn, or reverse.

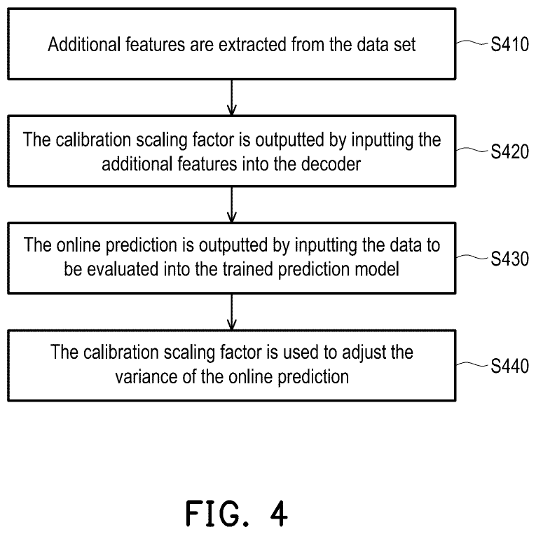

FIG. 4 is a flowchart of an uncertainty calibration method of prediction according to an embodiment of the disclosure. Referring to FIG. 4, the processor 120 extracts one or more additional features from the data set (step S410). Specifically, additional features are features generated based on the data set. Depending on the application scenario, the type of additional features may vary. Additional features may relate to motion, interaction, relative relationships, time and/or space. The data set may be a verification set or another type of data set. A data set includes one or more input samples. For the introduction of input samples, reference may be made to the aforementioned description of training samples, and is not repeated herein. For example, the data set includes M input samples {xⱼ,yⱼ,hⱼ}ⱼ₌₁^{M}, that is, xⱼ is the j^{th} historical trajectory, yⱼ is the j^{th} ground truth, and hⱼ is the j^{th} environmental information.

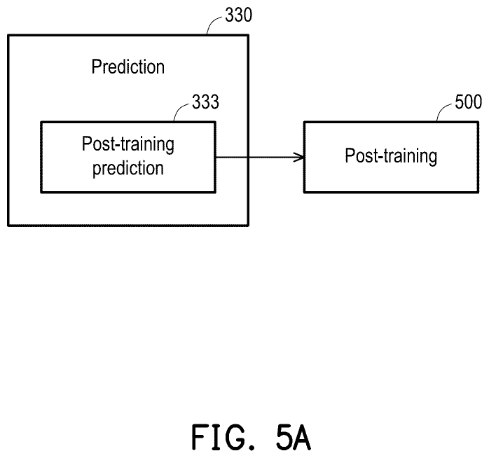

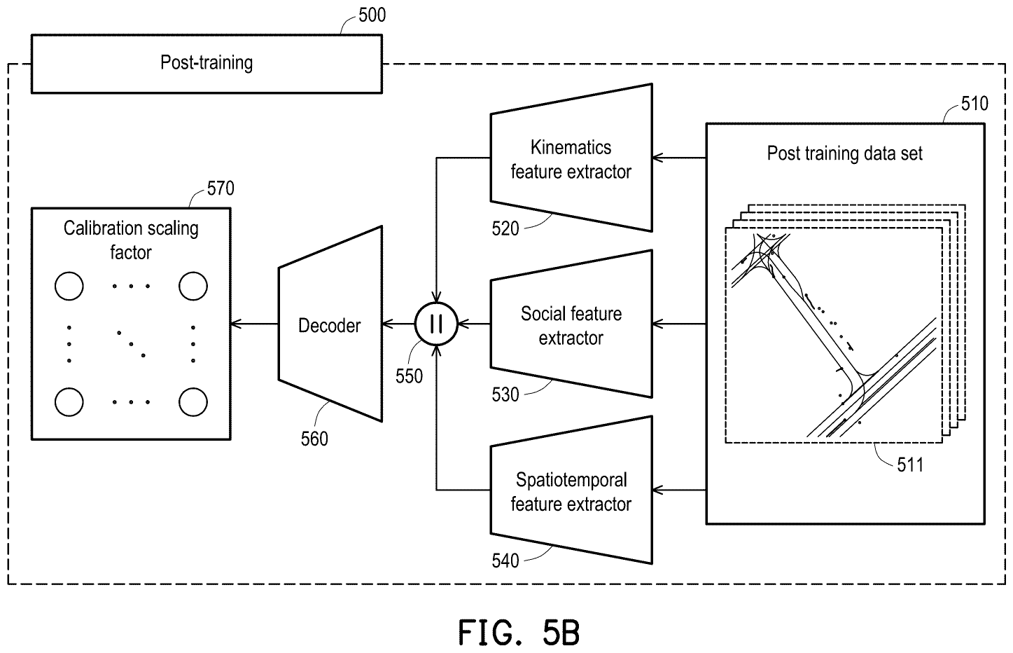

In one embodiment, the processor 120 outputs a prediction for post-training (post-training prediction) by inputting a data set into a trained prediction model. Specifically, FIG. 5A is a schematic diagram of prediction and post-training according to an embodiment of the disclosure. Referring to FIG. 5A, the prediction 330 of FIG. 3 may include a post-training prediction 333. The post-training prediction 333 is used for the post-training 500 of the trained prediction model, for example, parameters (e.g., the weight, number of layers, location or number of neurons, activation function, or offset) of the network or model used in the updated training 500. The post-training 500 is a series of techniques and strategies adopted after the prediction model has completed (initial) training (e.g., regularization training 300 in FIG. 3) in order to further improve its performance or adapt to new data. In some application scenarios, the post-training 500 may be fine-tuned or optimized based on the trained prediction model. The prediction 330 derived by the trained prediction model from the input data set (e.g., historical trajectory and/or sensing data) is the post-training prediction 333 (e.g., future trajectory).

FIG. 5B is a schematic diagram of post-training 500 according to an embodiment of the disclosure. Referring to FIG. 5B, the locations (i.e., past trajectories) of multiple past time points in the (post-processing/post-training) data set 510 may be mapped to a geographical coordinate system or a map, and an observation image 511 is generated accordingly. The (post-processing) data set 510 may include one or more observation images 511.

In one embodiment, the (post-processing) data set 510 includes the location of one or more target objects at one or more past time points, and the one or more additional features include kinematic features. The kinematic features may be velocity and/or acceleration. The processor 120 may execute the kinematics feature extractor 520 and determine the kinematic features by comparing locations corresponding to multiple past time points. For example, distance may be derived by comparing the location of two different future time points, which is used to calculate the velocity. Alternatively, the velocities at two different future time points are used to calculate the acceleration.

In one embodiment, the (post-processing) data set 510 includes the location of one or more target objects, and the additional features include social features. The social features are the distance to the target object and the number of target objects. The processor 120 may execute the social feature extractor 530 and determine the social features from the input samples in the (post-processing) data set 510. For example, the distance between the main object and the target object in the observation image 511 corresponding to a certain past time point and the number of target objects are calculated.

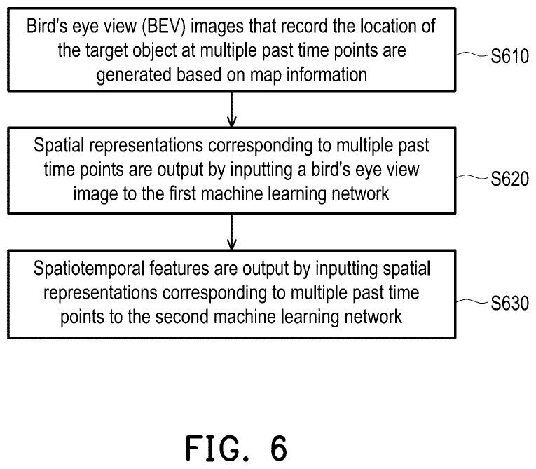

In one embodiment, the (post-processing) data set 510 includes the location of one or more target objects at one or more past time points, and the additional features include spatiotemporal features. The processor 120 may execute the spatiotemporal feature extractor 540 and obtain the spatiotemporal features. FIG. 6 is a flowchart of spatiotemporal feature extraction according to an embodiment of the disclosure. Referring to FIG. 6, the processor 120 may generate multiple top views that record the locations of one or more target objects at multiple past time points based on the map information (step S610). Specifically, the map information may be information on coordinates, routes, directions, road sections, buildings or other objects in a geographic information system (GIS). The processor 120 may generate a map image of a certain area (e.g., covering multiple locations in the trajectory) according to the map information.

The map image may be a view obtained by orthographic projection from above the object, that is, a top view or a bird's-eye view (BEV). Map images may include road areas, that is, the image area of the road. Then, the processor 120 may map the location of the target object at multiple past time points or past trajectories in the (post-processing) data set 510 to the map image. For example, a pattern or text is labeled on the corresponding location in the map image according to the latitude and longitude coordinates of one or more locations in the past trajectory. The mapped top view may be used as the observation image 511. In some embodiments, environmental information may also be referred to for location mapping.

The processor 120 may output spatial representations corresponding to multiple past time points by inputting one or more top views to the first machine learning network (step S620). Specifically, the first machine learning network is a network trained through a machine learning algorithm. The machine learning algorithm is, for example, a convolutional neural network (CNN), AlexNet related to a convolutional neural network, a very deep convolutional network (VGGNet), a residual neural network (ResNet), or Inception. During the training phase of the first machine learning network, the parameters of the first machine learning network are recursively updated by minimizing the loss function (related to the error/loss between the output of the first machine learning network and the ground truth in the input). The parameters of the first machine learning network are, for example, the weight, number of layers, location or numbers of neurons, activation function, or offset, but not limited thereto. The method of updating parameters is, for example, through a gradient descent, an adaptive moment estimation (Adam) optimizer, a momentum method, an adaptive gradient, or a conjugate gradient method, but not limited thereto. The spatial representation is, for example, the distance and/or direction in space between the main object and the target object, and the location of the lane line in space.

The processor 120 may output spatiotemporal features by inputting spatial representations corresponding to multiple past time points to the second machine learning network (step S630). Specifically, the second machine learning network is a network trained through a machine learning algorithm. The machine learning algorithm is, for example, a gated recurrent unit (GRU), a long short-term memory (LSTM), or a transformer. During the training phase of the second machine learning network, the parameters of the second machine learning network are recursively updated by minimizing the loss function (related to the error/loss between the output of the second machine learning network and the ground truth in the input). The parameters of the second machine learning network are, for example, the weight, number of layers, location or numbers of neurons, activation function, or offset, but not limited thereto. The method of updating parameters is, for example, through a gradient descent, an adaptive moment estimation (Adam) optimizer, a momentum method, an adaptive gradient, or a conjugate gradient method, but not limited thereto. The spatiotemporal features include, for example, the distance and/or direction in space between the main object and the target object at multiple (past) time points, and their correlation, as well as lane line movement information.

Referring to FIG. 5B, the processor 12 may combine kinematic features, social features and spatiotemporal features at the combination 550. A combination of kinematic features, social features, and spatiotemporal features is used as input to the decoder 560. The method of combination is, for example, concatenation or arrangement according to rules.

It should be noted that for other application fields, the type, content and extraction method of additional features may be different.

Referring to FIG. 4 and FIG. 5B, the processor 120 outputs the calibration scaling factor by inputting additional features to the decoder (step S420). Specifically, a decoder is a network with a linear layer accompanied by an activation function. The activation function is, for example, softplus, softmax, and swish, but not limited thereto. One or more weight coefficients are assigned to the linear layer. The additional features are respectively operated with these weight coefficients, and the operation output generates a calibration scaling factor through the activation function. The calibration scaling factor is a parameter used to scale down or scale up the variance, and will be described in detail in subsequent embodiments.

During the training phase of the encoder, the parameters of the encoder are recursively updated by minimizing the loss function (related to the error/loss between the output of the encoder and the ground truth corresponding to the additional feature). The parameters of the encoder are, for example, the weight, number of layers, location or number of neurons, activation function, or offset, but not limited thereto. The method of updating parameters is, for example, through a gradient descent, an adaptive moment estimation (Adam) optimizer, a momentum method, an adaptive gradient, or a conjugate gradient method, but not limited thereto.

In one embodiment, the processor 120 may update the parameters of the feature extractor (e.g., the kinematics feature extractor 520, the social feature extractor 530, and/or the spatiotemporal feature extractor 540 of FIG. 5) used to extract the additional features and/or the decoder 560 according to the data set, the post-training prediction 333 and the one or more additional features. For example, the loss function is defined through negative log-likelihood (NLL): −log P(yᵢ|\hat{μ}ᵢ,\hat{σ}ᵢ×γᵢ), in which, μᵢ at this time is the location or future trajectory of the future time point in the post-training prediction 333, and γᵢ is the i^{th} additional feature or a combination of multiple additional features. The parameters of the feature extractor (e.g., the kinematics feature extractor 520, the social feature extractor 530, and/or the spatiotemporal feature extractor 540 of FIG. 5) and/or decoder 560 are updated recursively using an update algorithm (e.g., an adaptive moment estimation (Adam) optimizer, a gradient descent, or an adaptive gradient) by minimizing the loss function.

Referring to FIG. 4, the processor 120 outputs online prediction 332 by inputting information to be evaluated into the trained prediction model (step S430). Specifically, for the generation of the online prediction 332, reference may be made to the foregoing description, and is not repeated herein.

The processor 120 adjusts the variance of the online prediction 332 through the calibration scaling factor (step S440). Specifically, the variance corresponds to the range of variation of the online prediction 332. For the variance, reference may be made to the previous description, and is not repeated herein. In one embodiment, the processor 120 scales up the variance of the online prediction 332 in response to the calibration scaling factor being greater than 1, for example, the range of variation of the location is increased. In another embodiment, the processor 120 scales down the variance of the online prediction 332 in response to the calibration scaling factor being less than 1, for example, the range of variation of the location is reduced.

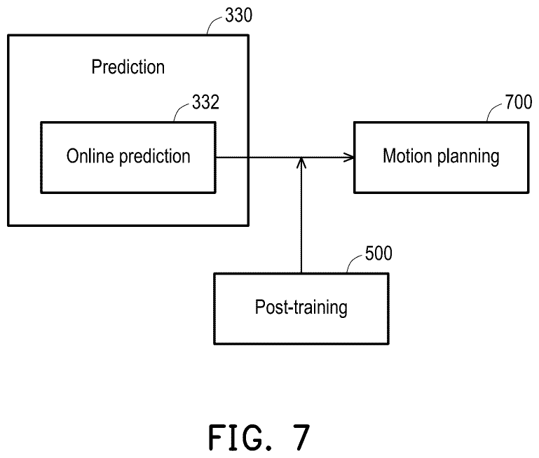

FIG. 7 is a schematic diagram of calibration according to an embodiment of the disclosure Referring to FIG. 7, the calibration scaling factor generated by post-training 500 may be used to calibrate the variance corresponding to online prediction 332. In one embodiment, the processor 120 may determine the motion planning data (i.e., execute motion planning 700) of the main object according to the online prediction 332 with the adjusted variance. The motion planning data includes motion parameters of the main object at one or more future time points.

For the introduction of motion planning data and motion parameters, reference may be made to the foregoing description, and are not repeated herein. An online prediction 332 with adjusted variance means that the variance of this online prediction 332 has been scaled up or down by the calibration scaling factor. Since the motion planning 700 may involve collision avoidance, a more reasonable driving path or motion planning parameters may be generated by calibrating the variance.

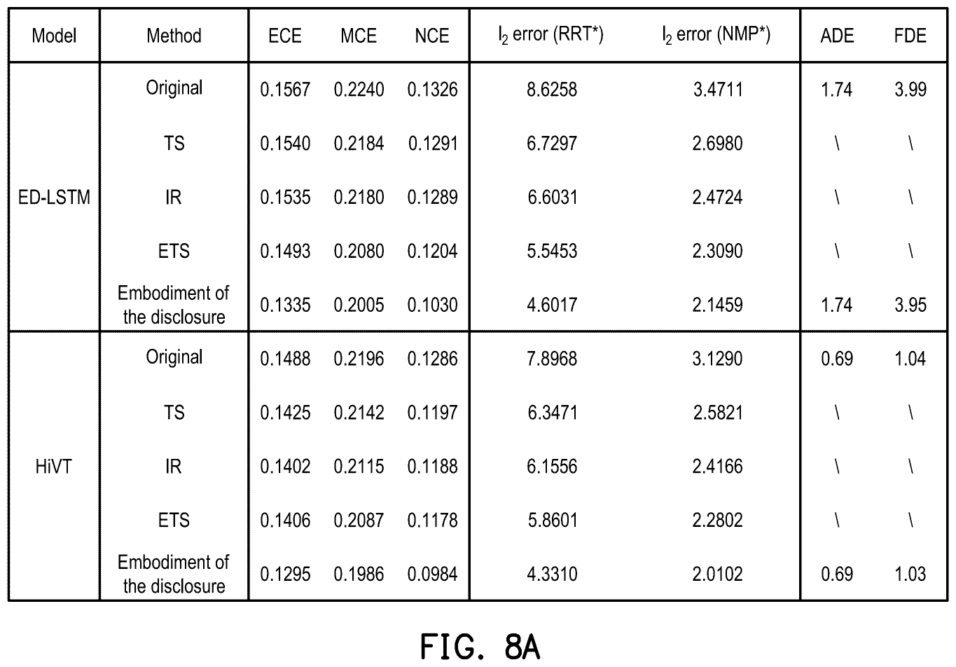

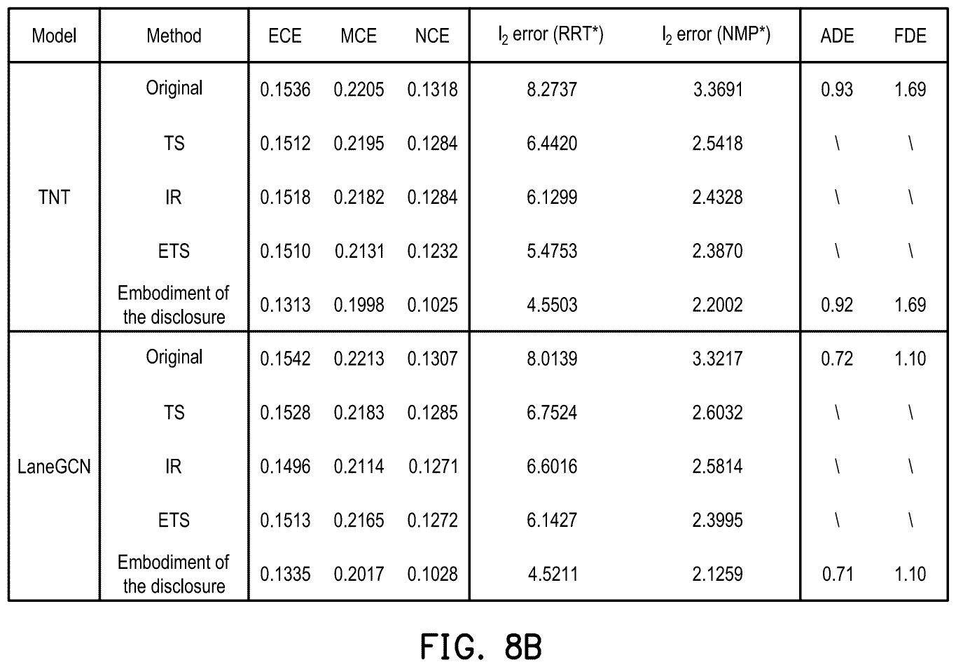

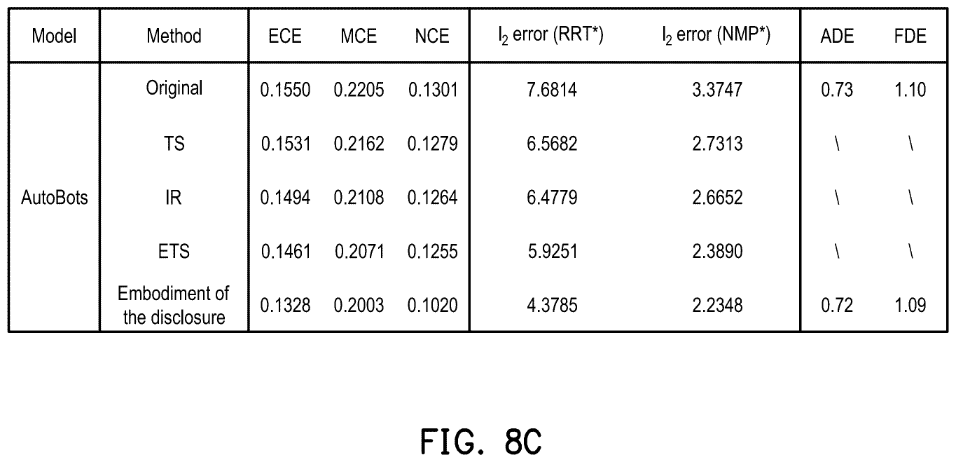

FIG. 8A to FIG. 8C are schematic diagrams illustrating performance verification according to an embodiment of the disclosure. Referring to FIG. 8A to FIG. 8C, the embodiment of the disclosure may be applied to a variety of machine learning models related to trajectory prediction, for example, ED-LSTM, HiVT, TNT, LaneGCN and AutoBots. The performance verification is conducted through simulations using the aforementioned models, respectively. Baselines include:

Temperature scaling (TS) utilizes a global temperature to scale the variance.
Isotonic regression (IR) trains an auxiliary model based on isotonic regression.
Ensemble Temperature Scaling (ETS) learns a mixture of uncalibrated, TS-calibrated, and uniform probabilistic outputs.

Calibration indicators include: expected calibration error (ECE), mean calibration error (MCE), and noise calibration error (NCE). The embodiment of the disclosure has the lowest three calibration indicators. The L2 error is for rapid exploration random tree (RRT) and neural message passing (NMP), and the errors of the embodiment of the disclosure are the lowest. Regarding average displacement error (ADE) and final displacement error (FDE), the errors of the embodiment of the disclosure are the lowest. It may be seen from this that the embodiment of the disclosure may improve the prediction accuracy of trajectory prediction and motion planning.

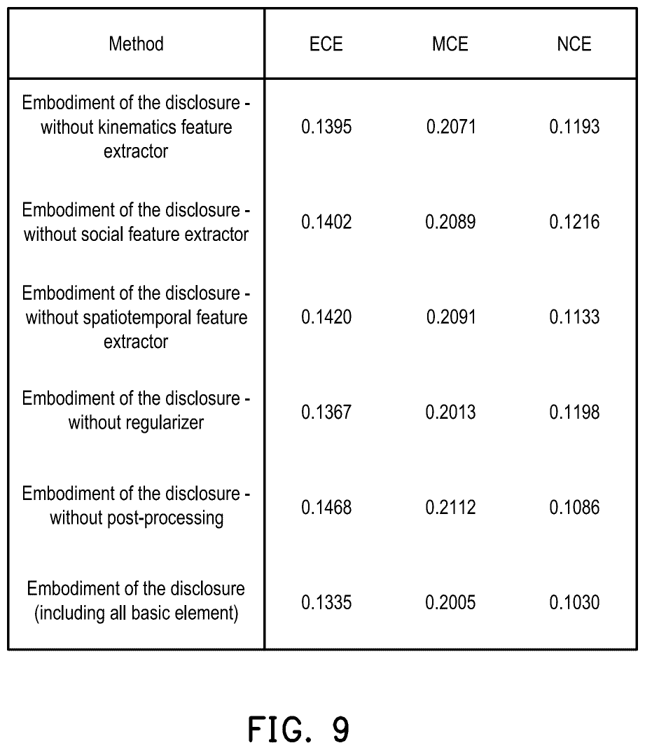

FIG. 9 is a schematic diagram illustrating performance verification of multiple basic elements according to an embodiment of the disclosure. Referring to FIG. 9, basic elements may include the regularizer 320 of FIG. 3, the kinematics feature extractor 520, the social feature extractor 530, the spatiotemporal feature extractor 540 of FIG. 5B, and the post-processing 500. The calibration indicators for executing the calibration procedures of all basic elements are the lowest. Although the absence of any single basic element results in higher calibration indicators, it is still within the tolerable range.

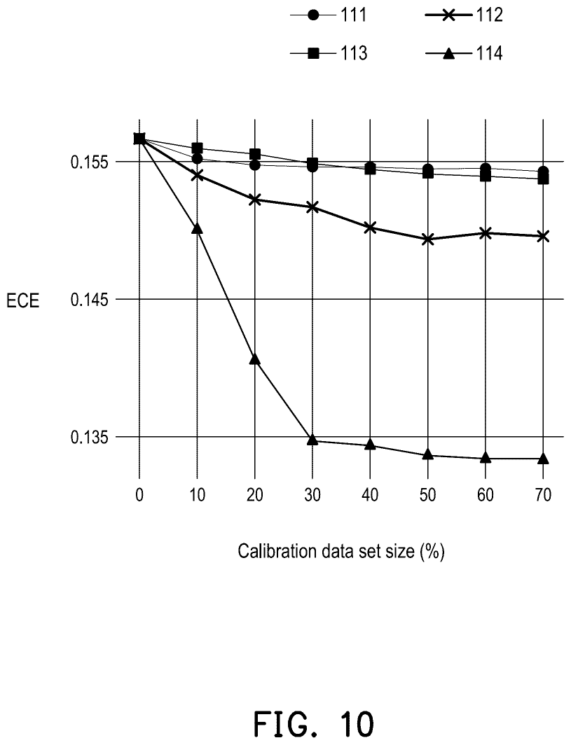

FIG. 10 is a diagram illustrating the relationship between sample size and expected calibration error (ECE) according to an embodiment of the disclosure. Referring to FIG. 10, the horizontal axis is the calibration data set size. As the calibration data set size increases, the expected calibration errors for temperature scaling 111, ensemble temperature scaling 112, and isotonic regression 113 are significantly higher than the expected calibration errors for embodiment of the disclosure 114. It may be seen from this that the embodiment of the disclosure may provide higher calibration performance.

To sum up, in the uncertainty calibration method of prediction and the calibration apparatus according to the embodiment of the disclosure, the additional features extracted from the data set are used to generate a calibration scaling factor, and the calibration scaling factor is used to adjust the variance corresponding to the prediction of the trained prediction model. In addition, the embodiment of the disclosure provides a corresponding loss function for the variance, so that the variance may better match the error between the prediction and the ground truth. In this way, the prediction performance and calibration data efficiency may be improved, and a better calibration baseline may be obtained.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An uncertainty calibration method of prediction, implemented by a processor, the uncertainty calibration method of prediction comprising:
extracting at least one additional feature from a data set;
outputting a calibration scaling factor by inputting the at least one additional feature into a decoder;
outputting an online prediction by inputting data to be evaluated into a trained prediction model; and
adjusting a variance of the online prediction by using the calibration scaling factor, wherein the variance corresponds to a range of variation of the online prediction.

2. The uncertainty calibration method of prediction according to claim 1, wherein the data set comprises a location of at least one target object at a past time point, the at least one additional feature comprises a kinematic feature, and extracting the at least one additional feature from the data set comprises:
determining the kinematic feature by comparing locations corresponding to a plurality of past time points.

3. The uncertainty calibration method of prediction according to claim 1, wherein the data set comprises a location of at least one target object, the at least one additional feature comprises a social feature, the social feature is a distance to the at least one target object and a number of the at least one target object, and extracting the at least one additional feature from the data set comprises:
determining the social feature from an input sample in the data set.

4. The uncertainty calibration method of prediction according to claim 1, wherein the data set comprises a location of at least one target object at a past time point, the at least one additional feature comprises a spatiotemporal feature, and extracting the at least one additional feature from the data set comprises:
generating a plurality of top views that record a location of the at least one target object at a plurality of past time points based on map information;
outputting spatial representation corresponding to the past time points by inputting the top views to a first machine learning network; and
outputting the spatiotemporal feature by inputting the spatial representation corresponding to the past time points to a second machine learning network.

5. The uncertainty calibration method of prediction according to claim 4, wherein the first machine learning network is a convolutional neural network (CNN).

6. The uncertainty calibration method of prediction according to claim 4, wherein the second machine learning network is a gated recurrent unit (GRU).

7. The uncertainty calibration method of prediction according to claim 1, wherein the data set comprises a location of at least one target object at a past time point, the at least one additional feature comprises a kinematic feature, a social feature and a spatiotemporal feature, and extracting the at least one additional feature from the data set comprises:
combining the kinematic feature, the social feature and the spatiotemporal feature, wherein a combination of the kinematic feature, the social feature and the spatiotemporal feature is used as input to the decoder.

8. The uncertainty calibration method of prediction according to claim 1, further comprising:
outputting a post-training prediction by inputting the data set into the trained prediction model; and
updating parameters of feature extractors used to extract the at least one additional feature and/or the decoder according to the data set, the post-training prediction, and the at least one additional feature.

9. The uncertainty calibration method of prediction according to claim 1, further comprising:
outputting an initial prediction by inputting a training set to an untrained prediction model in a training phase; and
updating parameters of the prediction model according to a total loss function, wherein the total loss function is a sum of negative log-likelihood (NLL) and a calibration loss function, the calibration loss function regularizes a difference between a first value and a second value, the first value is a square of a difference between the initial prediction and a corresponding ground truth, and the second value is a variance of the initial prediction.

10. The uncertainty calibration method of prediction according to claim 1, wherein the online prediction comprises a location of at least one target object at a future time point, the at least one target object is adjacent to a main object, and the uncertainty calibration method of prediction further comprises:
determining a motion planning data of the main object according to the online prediction with the variance that is adjusted, wherein the motion planning data comprises motion parameters of the main object at another future time point.

11. A calibration apparatus, comprising:
a memory, configured to store program code; and
a processor, coupled to the storage, and configured to load the program code to execute:
extracting at least one additional feature from a data set;
outputting a calibration scaling factor by inputting the at least one additional feature into a decoder;
outputting an online prediction by inputting data to be evaluated into a trained prediction model; and
adjusting a variance of the online prediction by using the calibration scaling factor, wherein the variance corresponds to a range of variation of the online prediction.

12. The calibration apparatus according to claim 11, wherein the data set comprises a location of at least one target object at a past time point, the at least one additional feature comprises a kinematic feature, and the processor is further configured to:
determine the kinematic feature by comparing locations corresponding to a plurality of past time points.

13. The calibration apparatus according to claim 11, wherein the data set comprises a location of at least one target object, the at least one additional feature comprises a social feature, the social feature is a distance to the at least one target object and a number of the at least one target object, and the processor is further configured to:
determine the social feature from an input sample in the data set.

14. The calibration apparatus according to claim 11, wherein the data set comprises a location of at least one target object at a past time point, the at least one additional feature comprises a spatiotemporal feature, and the processor is further configured to:
generate a plurality of top views that record a location of the at least one target object at a plurality of past time points based on map information;
output spatial representation corresponding to the past time points by inputting the top views to a first machine learning network; and
output the spatiotemporal feature by inputting the spatial representation corresponding to the past time points to a second machine learning network.

15. The calibration apparatus according to claim 14, wherein the first machine learning network is a convolutional neural network (CNN).

16. The calibration apparatus according to claim 14, wherein the second machine learning network is a gated recurrent unit (GRU).

17. The calibration apparatus according to claim 11, wherein the data set comprises a location of at least one target object at a past time point, the at least one additional feature comprises a kinematic feature, a social feature and a spatiotemporal feature, and the processor is further configured to:
combine the kinematic feature, the social feature and the spatiotemporal feature, wherein a combination of the kinematic feature, the social feature and the spatiotemporal feature is used as input to the decoder.

18. The calibration apparatus according to claim 11, wherein the processor is further configured to:
output a post-training prediction by inputting the data set into the trained prediction model; and
update parameters of feature extractors used to extract the at least one additional feature and/or the decoder according to the data set, the post-training prediction, and the at least one additional feature.

19. The calibration apparatus according to claim 11, wherein the processor is further configured to:
output an initial prediction by inputting a training set to an untrained prediction model in a training phase; and
update parameters of the prediction model according to a total loss function, wherein the total loss function is a sum of negative log-likelihood (NLL) and a calibration loss function, the calibration loss function regularizes a difference between a first value and a second value, the first value is a square of a difference between the initial prediction and a corresponding ground truth, and the second value is a variance of the initial prediction.

20. The calibration apparatus according to claim 11, wherein the online prediction comprises a location of at least one target object at a future time point, the at least one target object is adjacent to a main object, and the processor is further configured to:
determine a motion planning data of the main object according to the online prediction with the variance that is adjusted, wherein the motion planning data comprises motion parameters of the main object at another future time point.
